(19) United States
(12) Patent Application Publication
(10) Pub. No.: US 2025/0335719 A1
(43) Pub. Date: Oct. 30, 2025

(54) METHOD, ELECTRONIC DEVICE, AND PROGRAM PRODUCT FOR LARGE LANGUAGE MODEL

(71) Applicant: Dell Products L.P., Round Rock, TX (US)

(72) Inventors: Zijia Wang, London (GB); Tianlu Fei, Shanghai (CN); Sanping Li, Beijing (CN); Zhen Jia, Shanghai (CN)

(21) Appl. No.: 18/678,989

(22) Filed: May 30, 2024

(30) Foreign Application Priority Data
Apr. 26, 2024 (CN) 202410516899.6

(51) Int. Cl. G06F 40/40; G06F 40/35

(52) U.S. Cl. CPC G06F 40/40; G06F 40/35

(57) ABSTRACT

Embodiments of the present disclosure provide a method, an electronic device, and a program product for a large language model (LLM). The method includes: receiving a user input for an LLM agent; determining role information and user-related alignment information for the LLM agent based on the user input; generating a prompt including the role information and the alignment information; and generating an answer to the user input by providing the prompt to the LLM. In this way, appropriate role and user-related alignment information can be configured for the LLM agent to help the LLM agent to provide a desired answer for users in open application fields, thereby improving user experience.

### RELATED APPLICATION

The present application claims priority to Chinese Patent Application No. 202410516899.6, filed Apr. 26, 2024, and entitled “Method, Electronic Device, and Program Product for Large Language Model,” which is incorporated by reference herein in its entirety.

### FIELD

Embodiments of the present disclosure relate to the field of computers, and more particularly, relate to a method, an electronic device, and a program product for a large language model (LLM).

### BACKGROUND

A conversational question answering system based on an LLM is an artificial intelligence (AI) system that uses natural language to converse with humans. It integrates core concepts of a language model, deep learning, and a conversational system to achieve a natural interaction with humans. The LLM is typically implemented as a deep learning model trained on massive text data, which can generate natural language texts and deeply understand the meanings of texts. Through large-scale training, these models can process a variety of natural language tasks.

Prompts play an important role in a conversational AI system. In simple terms, prompts are texts or statements input by users when interacting with the system to trigger LLM responses and generate corresponding replies. Prompts may be complete questions, snippets of conversation, or even just words or sentences. Users express their needs or problems by inputting prompts, and the LLM understands and analyzes the users' intentions according to the prompts, and generates corresponding responses. The quality and accuracy of a prompt are critical to the quality and effectiveness of the responses generated by the LLM.

### SUMMARY

According to embodiments of the present disclosure, there is provided a technical solution for an LLM.

According to a first aspect of the present disclosure, a method is provided. The method includes: receiving a user input for an LLM agent; determining role information and user-related alignment information for the LLM agent based on the user input; generating a prompt including the role information and the alignment information; and generating an answer to the user input by providing the prompt to the LLM.

According to a second aspect of the present disclosure, an electronic device is provided. The electronic device includes at least one processor, and a memory coupled to the at least one processor and storing instructions. The instructions, when executed by the at least one processor, cause the electronic device to perform actions comprising: receiving a user input for an LLM agent; determining role information and user-related alignment information for the LLM agent based on the user input; generating a prompt including the role information and the alignment information; and generating an answer to the user input by providing the prompt to the LLM.

According to a third aspect of the present disclosure, a computer program product is provided. The computer program product is tangibly stored on a non-transitory computer-readable medium and comprises machine-executable instructions. The machine-executable instructions, when executed by a machine, cause the machine to perform actions comprising: receiving a user input for a LLM agent; determining role information and user-related alignment information for the LLM agent based on the user input; generating a prompt including the role information and the alignment information; and generating an answer to the user input by providing the prompt to the LLM.

### BRIEF DESCRIPTION OF THE DRAWINGS

The above and other features, advantages, and aspects of embodiments of the present disclosure will become more apparent with reference to the drawings and the Detailed Descriptions below. In the drawings, identical or similar reference numerals represent identical or similar elements, in which:

FIG. 1 is a schematic diagram of an example environment in which embodiments of the present disclosure can be implemented;

FIG. 2 is a block diagram of an LLM agent according to embodiments of the present disclosure;

FIG. 3 is a flow chart of a method for an LLM according to embodiments of the present disclosure;

FIG. 4 is a block diagram of an automatic role configuration module according to embodiments of the present disclosure;

FIG. 5 is a schematic diagram of an example of generating role information for an LLM agent according to embodiments of the present disclosure;

FIG. 6 is a block diagram of an automatic alignment configuration module according to embodiments of the present disclosure;

FIG. 7 is a flow chart of a method for generating user-related alignment information according to embodiments of the present disclosure;

FIG. 8 is a schematic diagram of an example of generating user-related alignment information according to embodiments of the present disclosure; and

FIG. 9 is a block diagram of an example device that can be used to implement some embodiments of the present disclosure.

### DETAILED DESCRIPTION

Illustrative embodiments of the present disclosure will be described below in further detail with reference to the drawings. Although the drawings show some embodiments of the present disclosure, it should be understood that the present disclosure may be implemented in various forms, and should not be construed as being limited to the embodiments stated herein. Rather, these embodiments are provided for understanding the present disclosure more thoroughly and completely. It should be understood that the drawings and embodiments of the present disclosure are for exemplary purposes only, and are not intended to limit the scope of protection of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or the same objects. Other explicit and implicit definitions may also be included below. Additionally, all specific numerical values herein are examples, which are provided only to aid in understanding, and are not intended to limit the scope.

LLM-based conversational AI and virtual assistants are increasingly being used, especially in the fields of customer service and product support. They provide enterprises with efficient and automated solutions to respond to users' queries, complaints, and suggestions. However, despite significant advances in these technologies, there are still some challenges in LLM development and configuration.

Existing LLM development methods have difficulties in achieving both good role-play and value alignment for an LLM agent. The role-play illustratively refers to an arrangement in which a model can interact with a user in appropriate ways according to different scenarios and role requirements. The role-play requires the LLM agent to adapt to different roles or figures in a conversation, where these roles or figures may have different language styles, emotional expressions, and field knowledge. However, existing role-play approaches are either data-intensive or field-specific, and thus cannot handle new roles efficiently. The value alignment requires the LLM agent to be consistent with the ethical values and preferences of human users or stakeholders when answering users' questions, where these ethical values and preferences may vary due to different fields and contexts. However, existing approaches are either too rigid or too costly to adapt to open-field scenarios.

These challenges make an LLM deployment into an open-field conversational AI application difficult. Open-field conversations cover a wide range of topics and issues and require models with strong semantic understanding and generation capabilities in order to be able to have natural and smooth conversations with users. In addition, different requirements of different users and contexts also increase the difficulty of the LLM deployment.

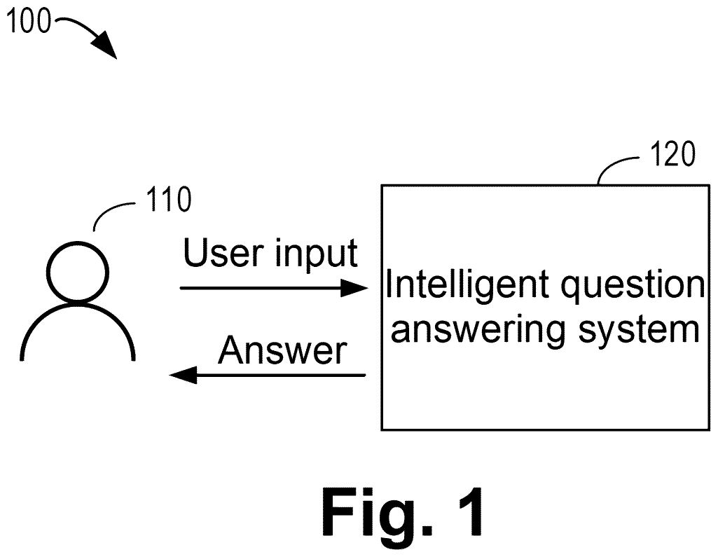

In view of this, embodiments of the present disclosure provide a framework for implementing a joint configuration of role and value alignment of an LLM agent. In the framework, the LLM agent receives a user input and automatically configures its role information and user-oriented alignment information based on the user input. The role information and the alignment information can be generated by the LLM or derived from transfer learning, multi-task learning, and so on. The LLM agent then combines the role information and the alignment information to form a prompt for being input into an LLM. Since such a prompt combines the role information and the alignment information that are automatically configured, the LLM can generate answers that are more in line with user expectations, thereby improving user experience. Some example embodiments of the present disclosure will be described below with reference to FIGS. 1-9.

FIG. 1 is a schematic diagram of an example environment 100 in which embodiments of the present disclosure can be implemented. As shown in the figure, the environment 100 includes a user 110 and an intelligent question answering system 120. The user 110 may be a human user who uses an electronic device with a network communication capability (e.g., a mobile phone, a desktop computer, a notebook computer, or a tablet computer) to provide a user input to the intelligent question answering system and expects the intelligent question answering system 120 to provide a desired answer. The intelligent question answering system 120 can be deployed in a computer cluster or on a single computer or server.

In some implementations, the intelligent question answering system 120 can provide responses or answers to the user input by running a large language model (LLM) agent. The LLM agent is designed to understand the input it receives and generate a human-like text. For example, the LLM agent can be a generative pre-trained transformer (GPT) model. The LLM agent is trained on large amounts of text data and uses a machine learning technology to understand and generate a coherent and context-related text. The LLM agent can be used for a variety of tasks including text generation, translation, summarization, question answering, etc. They are increasingly being used in applications such as chatbots, virtual assistants, content generation, and even creative writings. The word “agent” here means that the model autonomously processes and generates a text based on a received input, just like an intelligent agent or assistant. It is understood that embodiments of the present disclosure can also be applied to other environments, and are not limited to the intelligent question answering system 120 in FIG. 1.

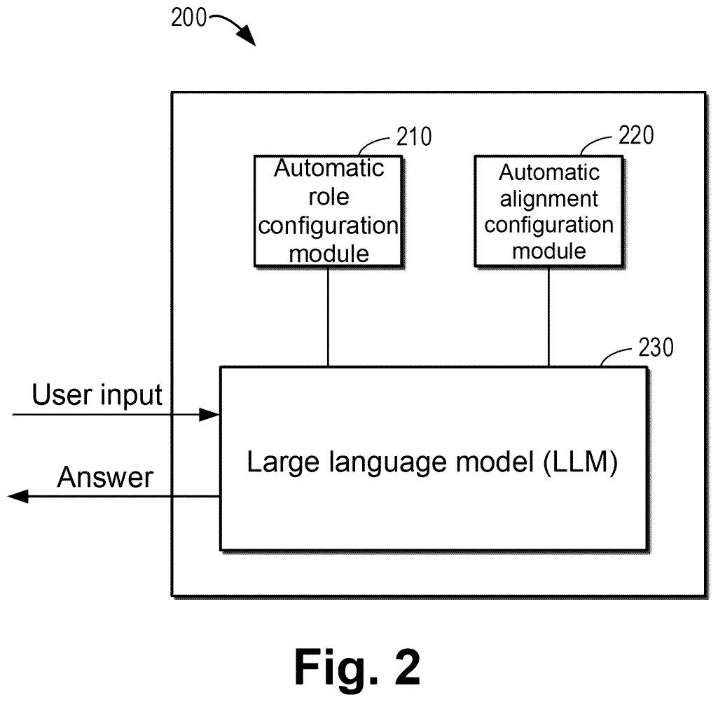

FIG. 2 is a block diagram of an LLM agent 200 according to embodiments of the present disclosure. As shown in the figure, the LLM agent 200 includes a trained LLM 230, which can have massive parameters, e.g., from a few billion to trillions of parameters. The LLM 230 can receive a user input as a prompt, and generate an answer according to the prompt. The LLM agent 200 further includes an automatic role configuration module 210 and an automatic alignment configuration module 220 that are coupled to the LLM 230, and can be seamlessly combined together to configure the LLM agent 200 such that the LLM agent 200 achieves role-play and value alignment in an open-field conversational AI application.

The automatic role configuration module 210 and the automatic alignment configuration module 220 can interact with a user through natural language or other modes. For example, the user can provide a natural language description or a snippet of conversation to guide the LLM agent 200 to adapt to a specific role and a specific scenario. The automatic role configuration module 210 can use semantic extraction, meta-learning, and priming to adapt the LLM agent 200 to a new role and a new scenario. The user can then have a natural conversation with the LLM agent 200, during which the user can further provide interactive feedback (e.g., corrections, preferences, and demonstrations) on the behaviors or actions of the LLM agent 200. The automatic alignment configuration module 220 can use interactive feedback, preference learning, transfer learning, multi-task learning, human supervision, and value or moral knowledge graphs to enable the answers and actions of the LLM agent 200 to be in line with the user's values and preferences.

In some embodiments, the automatic role configuration module 210 can be configured to determine role information for the LLM agent based on a user input. The role information can be in a text form and be input into the LLM 230 as a prompt to provide more context information.

For example, the role information can describe role names, expertise, language styles, emotional expressions, etc. The automatic role configuration module 210 can generate the role information using the LLM 230. For example, the automatic role configuration module 210 can request the LLM 230 to generate the role information by using the user input as part of a query (for example, using a structured template). In some embodiments, the automatic role configuration module 210 can extract semantic information, such as an entity, from the user input, and input the extracted language information into the LLM 230 as a role prompt and determine a response generated by the LLM 230 as the role information. Here, the meta-learning can provide an initialization parameter for the role prompt, while the priming can provide a small number of role examples to help quick configuration of a role of the LLM agent without the need for large amounts of training data.

In some embodiments, the automatic alignment configuration module 220 can be configured to determine alignment information based on the user input. Additionally or alternatively, the automatic alignment configuration module 220 can further be configured to obtain the alignment information based on transfer learning, multi-task learning, knowledge graphs, etc. Similar to the role information, the alignment information can be in a text form and be input into the LLM 230 as a prompt to provide more contextual information to assist generating an optimized answer to the user input. In some embodiments, the alignment information can include a user portrait of the user, an alignment target and an alignment strategy with which the LLM agent 200 interacts with the user, etc. For example, the user input can be input into the LLM 230 as a prompt to generate an alignment target which in turn can be input into the LLM 230 as a prompt to generate an alignment strategy. It should be noted that the alignment information can be adjusted according to the user's feedback on the answer (e.g. through interactive feedback, preference learning, etc.). Additionally or alternatively, the alignment information can also be adjusted in real time based on an evaluation on the alignment information, such as human supervision. In some embodiments, the prompt for the alignment information can be adjusted in real time so that the alignment information as a response is updated in real time accordingly.

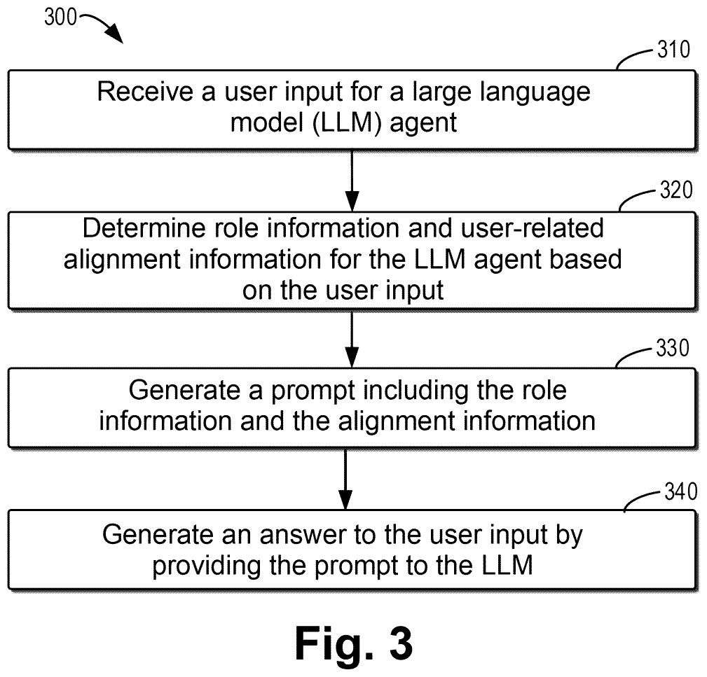

FIG. 3 is a flow chart of a method 300 for an LLM according to embodiments of the present disclosure. It should be understood that the method 300 may also include additional actions not shown and/or may omit actions shown, and the scope of the present disclosure is not limited in this regard. For ease of illustration, the method 300 is described with reference to FIG. 2.

At block 310, a user input for an LLM agent is received. In some embodiments, a user operation device sends a user input in a text form to a computer cluster or computing device running the LLM agent 200. Accordingly, the LLM agent 200 receives the user input. The LLM agent 200 may already have historical information about a user, or a current user may be a new user.

At block 320, role information and user-related alignment information for the LLM agent are determined based on the user input. The role information can be generated using the automatic role configuration module 210 in FIG. 2, and the alignment information can be generated using the automatic alignment configuration module 220 in FIG. 2.

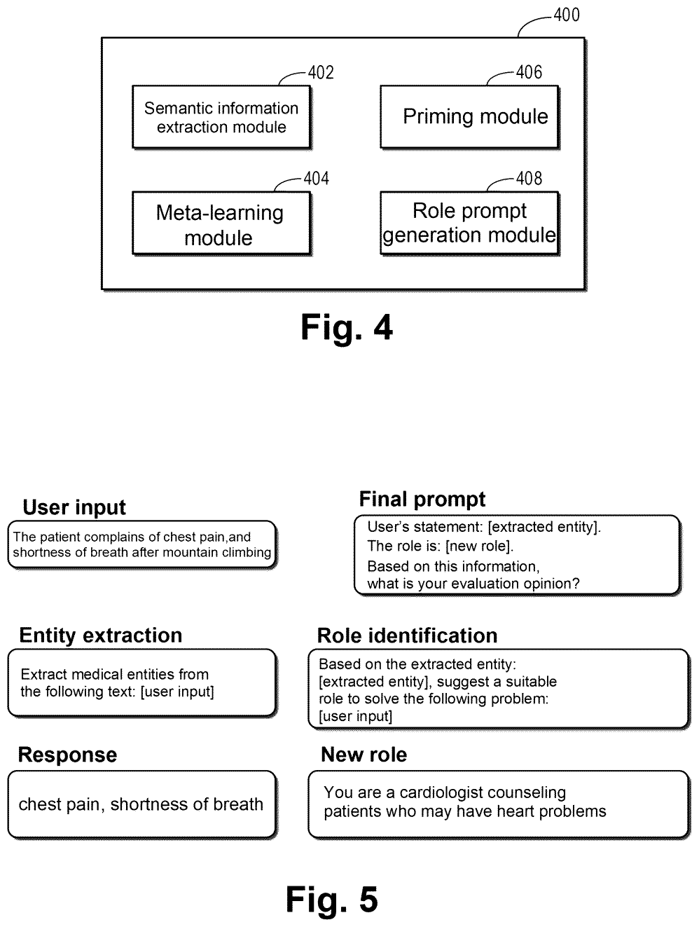

In some embodiments, the automatic role configuration module 210 can extract semantic information such as an entity from the user input, and then determine the role information for the LLM agent based on the semantic information. For example, the extracted entity can be filled into a query template, and input into the LLM 230 as a role prompt. Accordingly, the LLM 230 can generate a response as role information. A process of generating the role information using the LLM 230 will be further illustrated below with reference to FIGS. 4 and 5.

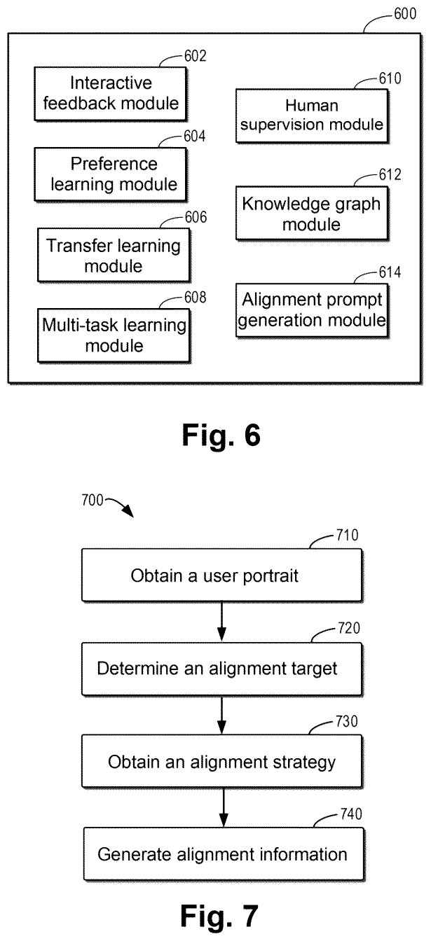

In some embodiments, the automatic alignment configuration module 220 can generate an alignment prompt from the user input and input the alignment prompt into the LLM 230. Accordingly, the LLM 230 can generate a response as alignment information. Both the alignment prompt and the alignment information can include a text content that reflects a value or attitude interacting with the user, including a user portrait, an alignment target for interaction with the user, an alignment strategy for interaction with the user, and so on. In some embodiments, the LLM 230 can generate an alignment target based on a user portrait, and generate an alignment strategy based on the alignment target. The user portrait, the alignment target, and the alignment strategy can be combined to form the alignment information. A process of generating the role information using the LLM 230 will be further illustrated below with reference to FIGS. 6-8.

At block 330, a prompt including the role information and the alignment information is generated. The role information and the alignment information can be combined with the user input in an appropriate manner to form the prompt. In some embodiments, the role information, the alignment information, and the user input can be added to a structured query template to be input into the LLM 230.

At block 340, an answer to the user input is generated by providing the prompt to the LLM. Based on the prompt for the role information and the alignment information, the LLM 230 can generate an answer that is in line with a current context and user value norms.

FIG. 4 is a block diagram of an automatic role configuration module 400 according to embodiments of the present disclosure. The automatic role configuration module 400 can be an exemplary implementation of the automatic role configuration module 210 in FIG. 2. It should be understood that some modules in the automatic role configuration module 400 can be omitted, and other modules not shown are further included.

The automatic role configuration module 400 enables an LLM agent to quickly adapt to a new role and a new scenario from a limited example. As shown in the figure, the automatic role configuration module 400 includes a semantic information extraction module 402, a meta-learning module 404, a priming module 406, and a role prompt generation module 408.

The semantic information extraction module 402 is configured to extract rich semantic information from a natural language text. For example, the semantic information extraction module 402 can extract named entities and types thereof, such as characters, locations, organizations, etc., from a user input. Additionally or alternatively, the semantic information extraction module 402 can also extract relationships and events from the text, such as who did what to whom, when, where, and why. Additionally or alternatively, the semantic information extraction module 402 can generate natural language descriptions from structured data, such as tables or graphs.

The meta-learning module 404 is configured to train the LLM agent to perform various role-play tasks and can quickly adapt to new role and scenario data with a small number of operations. In some embodiments, the meta-learning module 404 can provide an initialization parameter optimized for a role prompt, so that a relevant model after being trained can quickly learn a new role from an example of a specific role.

The priming module 406 prepares some role examples for the LLM agent to elicit a desired role-play behavior. Meta-learning helps to adapt quickly to a new role. In some embodiments, the priming module 406 can provide the LLM agent with a natural language description or a snippet of conversation to illustrate the name, expertise, language style, emotional expression, and so on of the role. In other words, the meta-learning module 404 and the priming module 406 may facilitate the definition of the new role.

The role prompt generation module 408 is configured to construct a role prompt input into the LLM based on the user input. In some embodiments, the role prompt generation module 408 can generate a role prompt using the semantic information extracted from the semantic information extraction module 402 and a role definition obtained from the meta-learning module 404 and the priming module 406. A response generated by the LLM 230 to the role prompt can be determined as a result of processing of the automatic role configuration module 400.

An advantage of the use of automatic role configuration is that data and computational requirements for configuring new roles and scenarios can be reduced, and the sample efficiency and robustness of the LLM agent can be improved. In addition, the automatic role configuration further can achieve online adaptation during an interaction. For example, the LLM agent can update its parameters based on user feedback or a conversation context.

FIG. 5 is a schematic diagram of an example of generating role information for an LLM agent according to embodiments of the present disclosure. In FIG. 5, for a user input “the patient complains of chest pain, and shortness of breath after mountain climbing” for the LLM agent, a semantic information extraction module adds the user input to a prompt, and the LLM then generates an extracted entity “chest pain, shortness of breath” based on the prompt as a response. The user input and the extracted entity are then further added to a prompt for role identification, and based on the prompt, the LLM generates new role information “you are a cardiologist counseling patients who may have heart problems.” The role information can be combined with the extracted entity and the user input to form a prompt for being input into the LLM to obtain an answer. As mentioned above, the prompt can also include user-related alignment information.

FIG. 6 is a block diagram of an automatic alignment configuration module 600 according to embodiments of the present disclosure. The automatic alignment configuration module 600 can be an exemplary implementation of the automatic alignment configuration module 220 in FIG. 2. It should be understood that some modules in the automatic alignment configuration module 600 can be omitted, and other modules not shown are further included.

The automatic alignment configuration module 600 enables an LLM agent to ensure that its actions and behaviors are in line with the values and preferences of its human users. The automatic alignment configuration module 600 includes an interactive feedback module 602, a preference learning module 604, a transfer learning module 606, a multi-task learning module 608, a human supervision module 610, a knowledge graph module 612, and an alignment prompt generation module 614.

The interactive feedback module 602 allows an end user to provide interactive feedback (corrections, preferences, and demonstrations) during a real-time interaction with the LLM agent. The feedback can be provided using natural language or other means, such as speech or gestures. The feedback can indicate that the actions or behaviors of the LLM agent in a conversation are desired by the user and appropriate, for example, the feedback is performed by way of a natural language expression or conversation behavior.

The preference learning module 604 is configured to update the values or ethics of the LLM agent based on the user feedback. The preference learning module 604 can learn a utility function or a ranking function from preference feedback that captures human values and preferences. For example, preference learning can learn a function that assigns higher scores to answers preferred by humans. The preference learning can further infer a reward function that explains why an optimal strategy maximizes an expected reward given by humans. In addition, reward modeling can be used to learn the reward function for predicting scores made by humans to the answers of the LLM agent.

The transfer learning module 606 is configured to transfer knowledge about values and ethics from a previous user to a new user. Transfer learning is a technology that uses knowledge learned from one or more source domains or tasks to improve the performance of a target domain or task. For example, the transfer learning can use a reward function learned from a user group to initialize or fine-tune a reward function for another user group.

The multi-task learning module 608 is configured to construct a general knowledge base of human values. Multi-task learning is a technology that uses a shared representation or model to optimize a plurality of tasks simultaneously. For example, the multi-task learning can use a shared encoder or decoder to learn common features or generate common outputs for different value alignment tasks, such as natural language understanding, conversation management, natural language generation, and value modeling.

The human supervision module 610 enables the answer of the LLM agent to be in line with user values. The human supervision module 610 allows humans to intervene or correct their behaviors when the LLM violates their values or preferences. For example, the human supervision module 610 can guide role information and alignment information generated by the LLM agent through step-by-step prompting and confirmation.

The knowledge graph module 612 maintains a knowledge graph in which some information can be input into the LLM as the alignment information. In addition, when a response of the LLM agent violates the user's values or preferences, the user uses the knowledge graph to intervene or correct its behavior. For example, human supervision can guide the actions of the LLM agent or verify the behaviors of the LLM agent through step-by-step prompting and confirmation.

The alignment prompt generation module 614 is configured to construct an alignment prompt that can be input into the LLM based on the user input. In some embodiments, the alignment prompt generation module 614 can generate an alignment prompt that can be input into the LLM 230 based on the user input. The response (i.e., alignment information) generated by the LLM 230 to the alignment prompt can be determined as a result of processing of the automatic alignment configuration module 600. The alignment information can include user portraits, alignment targets, alignment strategies, etc.

An advantage of use of automatic alignment configuration is that interactive feedback and real-time value alignment can be achieved through a natural interaction, where human users can provide feedback on the answers or actions of the LLM agent using natural language or other means. In addition, the automatic alignment configuration also can achieve human supervision during interactions, so that if the LLM agent violates the user's values or preferences, the user can intervene or correct the behaviors of the LLM agent.

FIG. 7 is a flow chart of a method 700 of generating user-related alignment information according to embodiments of the present disclosure. The method 700 can be an exemplary implementation of the automatic alignment configuration module 220 or 600 generating alignment information. It could be understood that some steps of the method 700 in FIG. 7 can be omitted, and other steps can further be included.

At block 710, a user portrait is obtained. The user portrait is information about a user's personality, values, preferences, background, and so on. The user portrait can be obtained explicitly by the user filling out a form or obtained implicitly by analyzing a current user input and past conversations. In some embodiments, the user input can be input into the LLM as a prompt, and then the LLM generates the user portrait.

At block 720, an alignment target is determined. Based on the user portrait, an alignment target that is consistent with the user, such as avoiding offensive language, providing empathy, and respecting privacy, is determined. In some embodiments, the user portrait can be input into the LLM as a prompt, and then the LLM can generate the alignment target.

At block 730, an alignment strategy is obtained. A strategy that helps achieve the alignment target that is consistent with the user can be found by searching an ethics database (such as the knowledge graph) or querying the LLM, where the strategy may include word choice, framework, tone, time arrangement, and the like. In some embodiments, the alignment target can be input into the LLM as a prompt, and then the LLM can generate the alignment strategy.

At block 740, alignment information is generated. In some embodiments, the alignment information can be formed by combining the user portrait, the alignment target, the alignment strategy, etc.

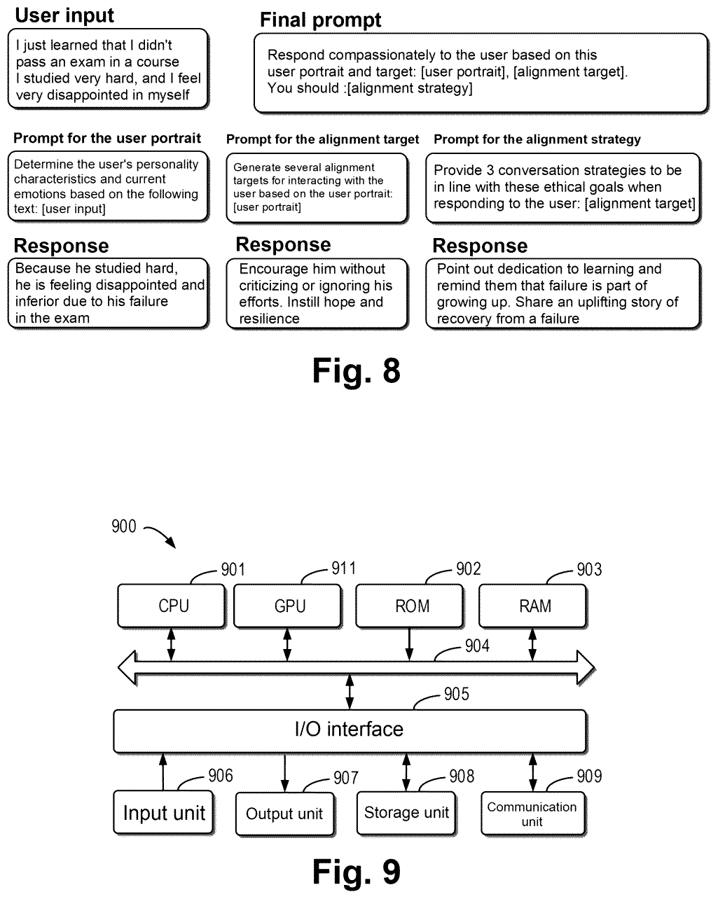

FIG. 8 is a schematic diagram of an example of generating user-related alignment information according to embodiments of the present disclosure. In the example in FIG. 8, alignment information is generated using an LLM. As shown in FIG. 8, a user input is “I just learned that I didn't pass an exam in a course I studied very hard, and I feel very disappointed in myself.” The user input can be added to a prompt for a user portrait, and a response “because he studied hard, he is feeling disappointed and inferior due to his failure in the exam” generated by the LLM based on the prompt can be determined as a current user portrait. The user portrait can then be added to a prompt for an alignment target, and a response “encourage him without criticizing or ignoring his efforts. Instill hope and resilience” generated by the LLM based on the prompt can be determined as an alignment target. The alignment target generated by the LLM is further added to a prompt for an alignment strategy, and a response “point out dedication to learning and remind them that failure is part of growing up. Share an uplifting story of recovery from a failure” generated by the LLM based on the prompt can be determined as an alignment strategy. The user portrait, the alignment target, and the alignment strategy generated by the LLM can be combined to form a prompt to be input into the LLM to obtain an answer. It could be understood that the prompt can further include user-related role information.

The foregoing describes illustrative embodiments of the present disclosure with reference to FIGS. 1-8. Compared with the prior art, according to some embodiments of the present disclosure, appropriate role and user alignment information can be configured for the LLM agent to help the LLM agent provide a desired answer for users in open application fields, thereby improving user experience.

FIG. 9 is a block diagram of an example electronic device 900 that may be used to implement some embodiments of the present disclosure.

As shown in FIG. 9, the electronic device 900 includes a central processing unit (CPU) 901 and a graphics processing unit (GPU) 911 that may perform various appropriate actions and processing according to computer program instructions stored in a read-only memory (ROM) 902 or computer program instructions loaded from a storage unit 908 to a random access memory (RAM) 903. Various programs and data required for the operation of the electronic device 900 may also be stored in the RAM 903. The CPU 901, the GPU 911, the ROM 902, and the RAM 903 are connected to one another through a bus 904. An input/output (I/O) interface 905 is also connected to the bus 904.

A plurality of components in the electronic device 900 are connected to the I/O interface 905 and include: an input unit 906, such as a keyboard and a mouse; an output unit 907, such as various types of displays and speakers; the storage unit 908, such as a magnetic disk and an optical disc; and a communication unit 909, such as a network card, a modem, and a wireless communication transceiver. The communication unit 909 allows the electronic device 900 to exchange information/data with other devices via a computer network such as the Internet and/or various telecommunication networks.

The various processes and processing described above can be executed by the CPU 901 and the GPU 911. For example, in some embodiments, methods or processes may be implemented as a computer software program tangibly included in a machine-readable medium such as the storage unit 908. In some embodiments, part or all of the computer program may be loaded and/or installed onto the electronic device 900 via the ROM 902 and/or the communication unit 909. One or more actions of methods or processes described above may be performed when the computer program is loaded into the RAM 903 and executed by the CPU 901.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein can be downloaded from a computer-readable storage medium to various computing/processing devices, or downloaded to an external computer or external storage device through a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

Computer program instructions for performing the operations of the present disclosure may be assembly instructions, Instruction Set Architecture (ISA) instructions, machine instructions, machine-related instructions, microcode, firmware instructions, state setting data, or source code or object code written in any combination of one or more programming languages, including object-oriented programming languages such as Smalltalk and C++, and conventional procedural programming languages such as “C” language or the like. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flow charts and/or block diagrams of the method, apparatus (system), and computer program product according to embodiments of the present disclosure. It should be understood that each block of the flow charts and/or the block diagrams and combinations of blocks in the flow charts and/or the block diagrams may be implemented by the computer-readable program instructions.

These computer-readable program instructions may be provided to a processing unit of a general-purpose computer, a special-purpose computer, or other programmable data processing apparatuses to produce a machine, such that these instructions, when executed by the processing unit of the computer or other programmable data processing apparatuses, produce means for implementing the functions/acts specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored thereon includes an article of manufacture that includes instructions that implement various aspects of the functions/actions specified in one or more blocks in the flow charts and/or block diagrams.

The computer-readable program instructions may also be loaded onto a computer, other programmable data processing apparatuses, or other devices, such that a series of operational steps are performed on the computer, other programmable data processing apparatuses, or other devices to produce a computer-implemented process, such that the instructions executed on the computer, other programmable data processing apparatuses, or other devices implement the functions/actions specified in one or more blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on the functions involved. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

Various embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated embodiments. The terms used herein are chosen to best explain the principles, practical applications, and technical improvements of the various embodiments, so as to enable those of ordinary skill in the art to understand the various embodiments disclosed herein.

What is claimed is:

1. A method for a large language model (LLM), comprising:
receiving a user input for an LLM agent;
determining role information and user-related alignment information for the LLM agent based on the user input;
generating a prompt including the role information and the alignment information; and
generating an answer to the user input by providing the prompt to the LLM.

2. The method according to claim 1, wherein determining role information for the LLM agent comprises:
extracting semantic information from the user input; and
determining the role information for the LLM agent based on the extracted semantic information.

3. The method according to claim 2, wherein determining the role information for the LLM agent comprises:
generating a role prompt based on the extracted semantic information; and
generating the role information by providing the role prompt to the LLM.

4. The method according to claim 3, further comprising:
generating the role prompt based on meta-learning and priming, wherein the meta-learning provides an initialization parameter for the role prompt and the priming provides one or more role examples.

5. The method according to claim 4, wherein the one or more role examples comprise at least one of: role name, expertise, language style, and emotional expression.

6. The method according to claim 1, wherein determining user-related alignment information comprises:
generating an alignment prompt for aligning with the user based on the user input; and
generating the alignment information by providing the alignment prompt to the LLM.

7. The method according to claim 6, wherein the alignment information comprises: at least one of a user portrait of the user, an alignment target for interaction with the user, and an alignment strategy for interaction with the user.

8. The method according to claim 1, wherein determining user-related alignment information comprises:
generating a first prompt for a user portrait based on the user input;
generating the user portrait by providing the first prompt to the LLM;
based on the user portrait, generating a second prompt for an alignment target for interaction with the user;
generating the alignment target by providing the second prompt to the LLM;
based on the alignment target, generating a third prompt for an alignment strategy for interaction with the user;
generating the alignment strategy by providing the third prompt to the LLM; and
generating the alignment information by combining the user portrait, the alignment target, and the alignment strategy.

9. The method according to claim 6, further comprising:
adjusting the alignment prompt based on feedback to the answer generated by the LLM or an evaluation on the alignment information; and
updating the alignment information using the adjusted alignment prompt.

10. The method according to claim 1, further comprising:
obtaining at least a portion of the alignment information by at least one of transfer learning, multi-task learning, and knowledge graphs.

11. An electronic device, comprising:
at least one processor; and
a memory coupled to the at least one processor and storing instructions, wherein the instructions, when executed by the at least one processor, cause the electronic device to perform actions comprising:
receiving a user input for a large language model (LLM) agent;
determining role information and user-related alignment information for the LLM agent based on the user input;
generating a prompt including the role information and the alignment information; and
generating an answer to the user input by providing the prompt to the LLM.

12. The electronic device according to claim 11, wherein determining role information for the LLM agent comprises:
extracting semantic information from the user input; and
determining the role information for the LLM agent based on the extracted semantic information.

13. The electronic device according to claim 12, wherein determining the role information for the LLM agent comprises:
generating a role prompt based on the extracted semantic information; and
generating the role information by providing the role prompt to the LLM.

14. The electronic device according to claim 13, wherein the actions further comprise:
generating the role prompt based on meta-learning and priming, wherein the meta-learning provides an initialization parameter for the role prompt and the priming provides one or more role examples.

15. The electronic device according to claim 14, wherein the one or more role examples comprise at least one of the following: role name, expertise, language style, and emotional expression.

16. The electronic device according to claim 11, wherein determining user-related alignment information comprises:
generating an alignment prompt for aligning with the user based on the user input; and
generating the alignment information by providing the alignment prompt to the LLM.

17. The electronic device according to claim 16, wherein the alignment information comprises: at least one of a user portrait of the user, an alignment target for interaction with the user, and an alignment strategy for interaction with the user.

18. The electronic device according to claim 11, wherein determining user-related alignment information comprises:
generating a first prompt for a user portrait based on the user input;
generating the user portrait by providing the first prompt to the LLM;
based on the user portrait, generating a second prompt for an alignment target for interaction with the user;
generating the alignment target by providing the second prompt to the LLM;
based on the alignment target, generating a third prompt for an alignment strategy for interaction with the user;
generating the alignment strategy by providing the third prompt to the LLM; and
generating the alignment information by combining the user portrait, the alignment target, and the alignment strategy.

19. The electronic device according to claim 16, wherein the actions further comprise:
adjusting the alignment prompt in real time based on feedback to the answer generated by the LLM or an evaluation on the alignment information; and
updating the alignment information in real time using the adjusted alignment prompt.

20. A computer program product, the computer program product being tangibly stored on a non-transitory computer-readable medium and comprising machine-executable instructions, wherein the machine-executable instructions, when executed by a machine, cause the machine to perform actions comprising:
receiving a user input for a large language model (LLM) agent;
determining role information and user-related alignment information for the LLM agent based on the user input;
generating a prompt including the role information and the alignment information; and
generating an answer to the user input by providing the prompt to the LLM.
